(19) United States
(12) Patent Application Publication
(10) Pub. No.: US 2022/0067807 A1
(43) Pub. Date: Mar. 3, 2022

(54) SYSTEM AND METHOD FOR FACILITATING ONE OR MORE FREIGHT TRANSACTIONS

(71) Applicant: Fero Tech Global Holdings Inc, Tortola (VG)

(72) Inventors: Abhinav Chaudhary, Dubai (AE); Naseer Ahmed, Dubai (AE)

(73) Assignee: Fero Tech Global Holdings Inc

(21) Appl. No.: 17/464,726

(22) Filed: Sep. 2, 2021

Related U.S. Application Data
(60) Provisional application No. 63/073,511, filed on Sep. 2, 2020.

(51) Int. Cl. G06Q 30/06; G06Q 30/02; G06Q 10/08; G06F 40/40

(52) U.S. Cl. CPC G06Q 30/0609; G06Q 30/0206; G06Q 10/0832; G06N 20/00; G06F 40/40; G06Q 10/08345; G06Q 30/0282; G06Q 30/0605

(57) ABSTRACT

A system and method for facilitating one or more freight transactions. The method includes receiving data representative of freight transaction from one or more users and extracting one or more details from the received data representative of freight transaction based on one or more transaction parameters by using one or more natural language processing techniques. The method further includes applying freight transaction based AI model on the extracted one or more details and generating one or more pricing quotes for the one or more freight forwarders corresponding to one or more freight transactions based on result of applying the freight transaction based AI model on the extracted one or more details. The method includes outputting the generated one or more pricing quotes corresponding to the one or more freight transactions on graphical user interface of one or more electronic devices associated with the one or more users.

### EARLIEST PRIORITY DATE

This application claims priority from a Provisional patent application filed in the United States of America having Patent Application No. 63/073,511, filed on Sep. 2, 2020, and titled “SYSTEM AND METHOD TO ASSIST AND EXECUTE ONE OR MORE FREIGHT TRANSACTIONS”.

### FIELD OF INVENTION

Embodiments of the present disclosure relate to a freight logistic sector virtual assistant system and more particularly relates to a system and a method for facilitating one or more freight transactions.

### BACKGROUND

Goods in transit refers to merchandise that has left shipping dock of a seller, but not yet received by buyer. Either the buyer or the seller is responsible for the goods in transit and costs associated with transportation. Determining whether this responsibility lies with the buyer, or the seller is critical in order to determine reporting requirements of retailer or merchandiser. Freight transactions refer to shipping costs incurred by the buyer while receiving shipment from the seller, such as delivery and insurance expenses. Further, traditional freight transactions use manual coordination between stake holders for sharing various information associated with freight transactions, such as delivery of one or more products and driver details. The manual coordination between the stake holders is a tedious task and requires a lot of human intervention. Furthermore, the freight forwarding industry requires multiple repetitive tasks and the traditional system uses manual coordination for these repetitive tasks by means of information sharing and gathering via one or more communication means such as calls, mails and the like with different sellers and buyers. Thus, the traditional system is a time-consuming process and may lead to delay in the whole freight transactions. Further, the traditional system requires redundant manual coordination to receive details associated with the freight transactions, such as updates on a shipment or a transaction and the like. The redundant manual coordination makes it difficult for the customer to track the shipment. Hence, the traditional system is not user-friendly.

Hence, there is a need for a system and method for facilitating one or more freight transactions in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for facilitating one or more freight transactions is disclosed. The computing system includes one or more hardware processors and a memory coupled to the one or more hardware processors. The memory includes a plurality of modules in the form of programmable instructions executable by the one or more hardware processors. The plurality of modules include a data receiver module configured to receive data representative of freight transaction from one or more users via one or more external sources. The data representative of freight transaction includes one or more queries of the one or more users, one or more instructions from the one or more users and labelled data. The one or more users include one or more freight forwarders, one or more shippers and one or more carriers. The one or more external sources include virtual assistant, web browser and messaging platform. The plurality of modules also include a data extraction module configured to extract one or more details from the received data representative of freight transaction based on one or more transaction parameters by using one or more natural language processing techniques. The one or more details include location of the one or more users, one or more instructions associated with the one or more users and one or more price parameters associated with the one or more users. The plurality of modules further include a model application module configured to apply freight transaction based Artificial Intelligence (AI) model on the extracted one or more details. Furthermore, the plurality of modules include a data generation module configured to generate one or more pricing quotes for the one or more freight forwarders corresponding to one or more freight transactions based on result of applying the freight transaction-based AI model on the extracted one or more details. Also, the plurality of modules include a data output module configured to output the generated one or more pricing quotes corresponding to the one or more freight transactions on graphical user interface of one or more electronic devices associated with the one or more users.

In accordance with another embodiment of the present disclosure, a method for facilitating one or more freight transactions is disclosed. The method includes receiving data representative of freight transaction from one or more users via one or more external sources. The data representative of freight transaction includes one or more queries of the one or more users, one or more instructions from the one or more users and labelled data. The one or more users include one or more freight forwarders, one or more shippers and one or more carriers. The one or more external sources include virtual assistant, web browser and messaging platform. The method also includes extracting one or more details from the received data representative of freight transaction based on one or more transaction parameters by using one or more natural language processing techniques. The one or more details include location of the one or more users, one or more instructions associated with the one or more users and one or more price parameters associated with the one or more users. The method further includes applying freight transaction based Artificial Intelligence (AI) model on the extracted one or more details. Further, the method includes generating one or more pricing quotes for the one or more freight forwarders corresponding to one or more freight transactions based on result of applying the freight transaction-based AI model on the extracted one or more details. Also, the method includes outputting the generated one or more pricing quotes corresponding to the one or more freight transactions on graphical user interface of one or more electronic devices associated with the one or more users.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1A is a block diagram illustrating an exemplary computing environment capable of facilitating one or more freight transactions, in accordance with an embodiment of the present disclosure;

FIG. 1B is a block diagram illustrating an exemplary computing environment capable of facilitating the one or more freight transactions, in accordance with another embodiment of the present disclosure;

FIG. 2 is a block diagram illustrating an exemplary computing system, such as those shown in FIG. 1, capable of facilitating the one or more freight transactions, in accordance with an embodiment of the present disclosure; and

FIG. 3 is a process flow diagram illustrating an exemplary method for facilitating the one or more freight transactions, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

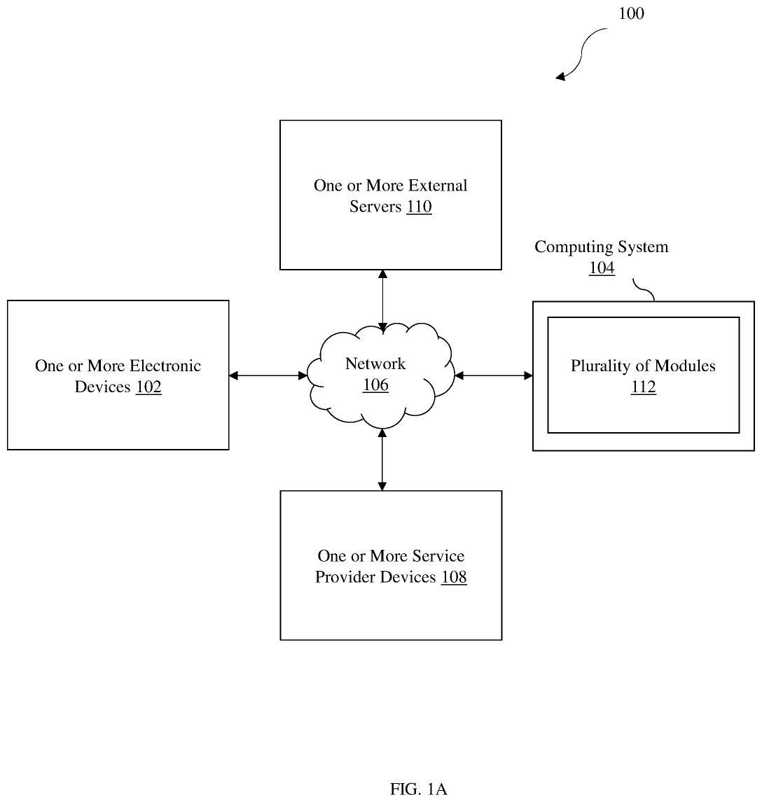

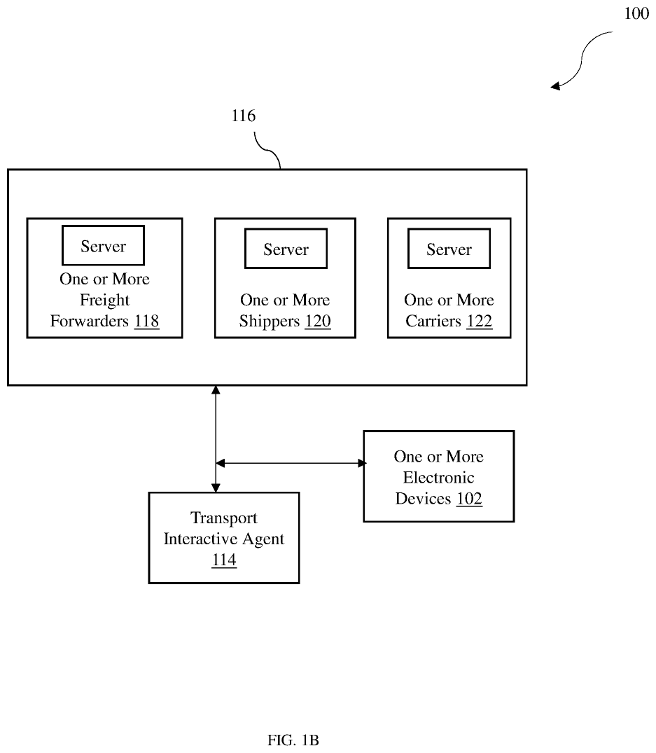

Referring now to the drawings, and more particularly to FIG. 1A through FIG. 3, where similar reference characters denote corresponding features consistently throughout the figures, there are shown preferred embodiments and these embodiments are described in the context of the following exemplary system and/or method.

FIG. 1A is a block diagram illustrating an exemplary computing environment capable of facilitating one or more freight transactions, in accordance with an embodiment of the present disclosure. In an embodiment of the present disclosure, the one or more freight transactions refer to shipping costs incurred by buyer while receiving shipment from seller. In an exemplary embodiment of the present disclosure, the shipping costs may include delivery, insurance expenses and the like. According to FIG. 1A, the computing environment 100 includes one or more electronic devices 102 associated with one or more users communicatively coupled to a computing system 104 via a network 106. In an exemplary embodiment of the present disclosure, the one or more users include one or more freight forwarders, one or more shippers, one or more carriers and the like. The one or more users may use the one or more electronic devices 102 for receiving one or more pricing quotes, order report, customized one or more price quotes, one or more optimize recommendations and the like. In an exemplary embodiment of the present disclosure, the computing system 104 may work as an interactive virtual assistant for assisting the one or more users in the one or more freight transactions. The computing system 104 may be a central server, such as cloud server or a remote server. In an exemplary embodiment of the present disclosure, the network 106 may be internet. Further, the computing environment 100 includes one or more service provider devices 108 associated with one or more service providers communicatively coupled to the computing system 104 via the network 106. The one or more service providers may use the one or more service provider devices 108 for receiving one or more recommendations to improve quality of service, providing one or more updates related to the one or more pricing quotes and the like. The one or more electronic devices 102 and the one or more service provider devices 108 may be a laptop computer, desktop computer, tablet computer, smartphone, wearable device, smart watch, virtual assistant device and the like.

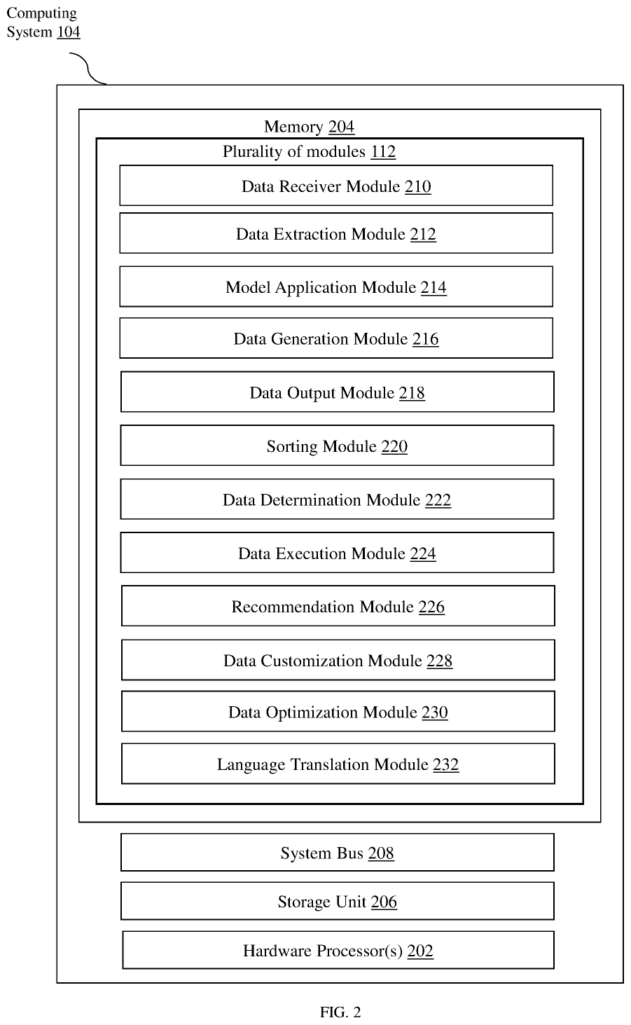

Further, the computing environment 100 includes one or more external servers 110 communicatively coupled to the computing system 104 via the network 106. In an exemplary embodiment of the present disclosure, the one or more external servers 110 may include one or more Enterprise resource planning (ERP) servers. In an embodiment of the present disclosure, the computing system 104 may receive data representative of freight transaction from the one or more external servers 110. In an exemplary embodiment of the present disclosure, the data representative of freight transaction includes one or more queries of the one or more users, one or more instructions from the one or more users and labelled data. Furthermore, the one or more electronic devices 102 and the one or more service provider devices 108 include a web browser, a virtual assistant, a messaging platform and a mobile application to access the computing system 104 via the network 106. In an exemplary embodiment of the present disclosure, the messaging platform may be an internet based messaging platform. In an embodiment of the present disclosure, the one or more users may use a web application through the web browser to access the computing system 104. Further, the computing system 104 includes a plurality of modules 112. Details on the plurality of modules 112 have been elaborated in subsequent paragraphs of the present description with reference to FIG. 2.

In an embodiment of the present disclosure, the computing system 104 is configured to receive the data representative of freight transaction from the one or more users via one or more external sources. The computing system 104 extracts one or more details from the received data representative of freight transaction based on one or more transaction parameters by using one or more natural language processing techniques. The one or more details include location of the one or more users, one or more instructions associated with the one or more users and one or more price parameters associated with the one or more users. Further, the computing system 104 applies freight transaction based Artificial Intelligence (AI) model on the extracted one or more details. The computing system 104 generates one or more pricing quotes for the one or more freight forwarders corresponding to one or more freight transactions based on result of applying the freight transaction-based AI model on the extracted one or more details. Furthermore, the computing system 104 outputs the generated one or more pricing quotes corresponding to the one or more freight transactions on graphical user interface of the one or more electronic devices 102 associated with the one or more users.

FIG. 1B is a block diagram illustrating an exemplary computing environment capable of facilitating the one or more freight transactions, in accordance with another embodiment of the present disclosure. The computing environment 100 includes a transport interactive agent (TIA) 114 to assist and execute the one or more freight transactions. In an embodiment of the present disclosure, the TIA 114 may be the computing system 104 working as the interactive virtual assistant for assisting the one or more users 116 in the one or more freight transactions. The computing environment 100 includes the one or more electronic devices 102 to receive the data representative of freight transaction from the one or more users 116 via one or more servers associated with the one or more users 116. In an exemplary embodiment of the present disclosure, the one or more users 20 includes the one or more freight forwarders 118, one or more shippers 120, one or more carriers 122 and the like.

FIG. 2 is a block diagram illustrating an exemplary computing system 104, such as those shown in FIG. 1, capable of facilitating one or more freight transactions. The computing system 104 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 includes a data receiver module 210, a data extraction module 212, a model application module 214, a data generation module 216, a data output module 218, a data determination module 220, a data execution module 222, a report generation module 224, a recommendation module 226, a data customization module 228, a data optimization module 230 and a language translation module 232.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

The storage unit 206 may be a cloud storage. The storage unit 206 may store data representative of freight transaction and one or more transaction parameters. The storage unit 206 may also store the one or more pricing quotes, one or more analysis parameters, one or more order parameters, predefined information and the like.

The data receiver module 210 is configured to receive data representative of freight transaction from one or more users 116 via one or more external sources. In an exemplary embodiment of the present disclosure, the data representative of freight transaction includes one or more queries of the one or more users 116, one or more instructions from the one or more users 116, labelled data and the like. In an exemplary embodiment of the present disclosure, the one or more users 116 include one or more freight forwarders 118, one or more shippers 120, one or more carriers 122 and the like. The one or more freight forwarders 118 are agents acting as consolidators of freight. In an embodiment of the present disclosure, the one or more external sources include virtual assistant, web browser, messaging platform and the like. In an alternative embodiment of the present disclosure, the data receiver module 210 may be configured to receive the data representative of freight transaction from one or more external servers 110. In an exemplary embodiment of the present disclosure, the one or more external servers 110 include one or more Enterprise resource planning (ERP) servers and the like. In an embodiment of the present disclosure, the data representative of freight transaction may be received via one or more mediums. In an exemplary embodiment of the present disclosure, the one or more mediums include one or more voice-based messages from the one or more users 116, one or more text-based messages from the one or more users 116 and the like.

The data extraction module 212 is configured to extract one or more details from the received data representative of freight transaction based on one or more transaction parameters by using one or more natural language processing techniques. The one or more transaction parameters include freight order details, commodity, description, weight, source, destination, volume, consignee, shipper and the like. In an exemplary embodiment of the present disclosure, the one or more details include location of the one or more users 116, one or more instructions associated with the one or more users 116 and one or more price parameters associated with the one or more users 116. In an exemplary embodiment of the present disclosure, the one or more natural language processing techniques include a sentiment analysis technique, a text summarization technique and the like.

The model application module 214 is configured to apply freight transaction based Artificial Intelligence (AI) model on the extracted one or more details. Further, the data generation module 216 is configured to generate one or more pricing quotes for the one or more freight forwarders 118 corresponding to the one or more freight transactions based on result of applying the freight transaction-based AI model on the extracted one or more details. In an alternate embodiment of the present disclosure, the one or more pricing quotes for the one or more freight forwarders 118 may be fetched from the one or more service providers via one or more communication networks. In an exemplary embodiment of the present disclosure, the one or more communication networks may include electronic mail, messaging platform and the like. In an alternative embodiment of the present disclosure, the data generation module 216 is configured to embed one or more unknown parameters by using one or more algorithms to generate data for the one or more unknown parameters to provide the one or more pricing quotes to the one or more users 116. In an exemplary embodiment of the present disclosure, the one or more algorithms include agglomerative clustering, K—nearest neighbour algorithms and the like.

The data output module 218 is configured to output the generated one or more pricing quotes corresponding to the one or more freight transactions on graphical user interface of one or more electronic devices 102 associated with the one or more users 116.

In an embodiment of the present disclosure, the data determination module 220 analyzes the one or more pricing quotes provided by the one or more service providers to segregate at least one of the one or more pricing quotes based on the one or more transaction parameters provided by the one or more users 116. The data determination module 220 is configured to determine one or more analysis parameters by analyzing the one or more pricing quotes. In an exemplary embodiment of the present disclosure, the one or more analysis parameters include one or more advantages associated with one or more service providers, one or more disadvantages associated with the one or more service providers and the like. Further, the data output module 218 outputs the determined one or more analysis parameters on graphical user interface of the one or more electronic devices 102.

The data customization module 228 is configured to receive one or more updates from the one or more service provides about the one or more pricing quotes. In an embodiment of the present disclosure, the one or more service providers provides the one or more updates via the one or more service provider devices 108. The one or more updates include an increase in the one or more pricing quotes, a decrease in the one or more pricing quotes and the like. Further, the data customization module 228 customizes the one or more price quotes based on the received one or more updates. The customized one or more price quotes is outputted on graphical user interface of the one or more electronic devices 102. In an embodiment of the present disclosure, the data output module 218 may output the customized one or more price quotes to the one or more freight forwarders 118 after a pre-defined interval of time. The data execution module 222 is configured to receive a final price quote associated with the one or more pricing quotes from the one or more freight forwarders 118. Furthermore, the data execution module 222 is configured to generate a notification associated with the final price quote for executing a shipment process of one or more orders associated with the one or more users 116. In an embodiment of the present disclosure, the data customization module 228 is also configured to receive one or more updates related to exception in the one or more orders during shipment process of one or more orders, such that each user may be notified about the received one or more updates.

The report generation module 224 is configured to track the one or more orders associated with the one or more users 116 upon execution of shipment process. Further, the report generation module 224 receives one or more order parameters associated with the one or more orders from the one or more users 116. In an exemplary embodiment of the present disclosure, the one or more order parameters include an order number, destination of the one or more orders, type of the one or more orders and the like. The report generation module 224 fetches order information associated with the one or more orders based on the result of tracking the one or more orders and the received one or more order parameters. The order information includes one or more order status details, one or more driver details and one or more destination details associated with the one or more orders. In an exemplary embodiment of the present disclosure, the one or more order status details include an order number, estimated delivery date and time associated with the one or more orders, number of units of a product, a type of order, carrier name, shipper name and the like. In an exemplary embodiment of the present disclosure, the one or more driver details include name of a driver, contact number of the driver, vehicle number associated with the driver and the like. In an exemplary embodiment of the present disclosure, the one or more destination details include waiting time, number of parking slots, number of ramps and the like. Furthermore, the report generation module 224 generates an order report corresponding to each order based on the fetched information. The generated report is transmitted on graphical user interface of the one or more electronic devices 102. In an embodiment of the present disclosure, the generated report may be transmitted via internet-based messaging platform, linked to natural language techniques and superimposition on required tracking milestones on maps for order lifecycle and the like.

The recommendation module 226 configured is to obtain one or more responses associated with the shipment of the one or orders by prompting one or more questionnaires to the one or more users 116. In an embodiment of the present disclosure, the recommendation module 226 may also obtain one or more responses in the form of feedback. Further, the recommendation module 226 is configured to determine a rating corresponding to each of one or more service providers based on the obtained one or more responses. The recommendation module 226 is configured to generate one or more recommendations to improve quality of service of the one or more service providers based on the generated rating and predefined information. The generated one or more recommendations are outputted on graphical user interface of the one or more service provider devices 108.

The data optimization module 230 is configured to receive one or more constraints from the one or more users 116. In an exemplary embodiment of the present disclosure, the one or more constrains include time, money, resources and the like. Further, the data optimization module 230 generates one or more optimize recommendations based on the received one or more constraints for decision and execution of the one or more orders. The generated one or more optimize recommendations are outputted on graphical user interface of the one or more electronic devices 102.

The language translation module 232 translates one or more languages associated with the one or more pricing quotes, the one or more analysis parameter, the order report, the one or more recommendations, the one or more optimize recommendations and the like to another language as decided by the one or more users 116 by using the one or more natural language processing techniques. For example, when a user desires to access the order report and he/she only understands Punjabi language, the language translation module 232 translates the order report from English language to Punjabi language. Further, the language translation module 232 may also translate information received from the user in Punjabi language to another language understood by other users.

In operation, the computing system 104 receives the data representative of freight transaction from the one or more users 116. Further, the computing system 104 extracts the one or more details from the received data representative of freight transaction based on the one or more transaction parameters by using the one or more natural language processing techniques. The computing system 104 applies the freight transaction-based AI model on the extracted one or more details to generate the one or more pricing quotes for the one or more freight forwarders 118 corresponding to the one or more freight transactions. Furthermore, the computing system 104 outputs the generated one or more pricing quotes corresponding to the one or more freight transactions on graphical user interface of the one or more electronic devices 102 associated with the one or more users 116. The computing system 104 also determines the one or more analysis parameters by analyzing the one or more pricing quotes. The computing system 104 tracks the one or more orders associated with the one or more users 116 upon execution of the shipment process. Further, the computing system 104 receives the one or more order parameters associated with the one or more orders from the one or more users 116. The computing system 104 fetches the order information associated with the one or more orders based on the result of tracking the one or more orders and the received one or more order parameters and generate the order report based on the fetched information. In an embodiment of the present disclosure, the computing system 104 may work as the interactive virtual assistant for performing the above-mentioned method steps.

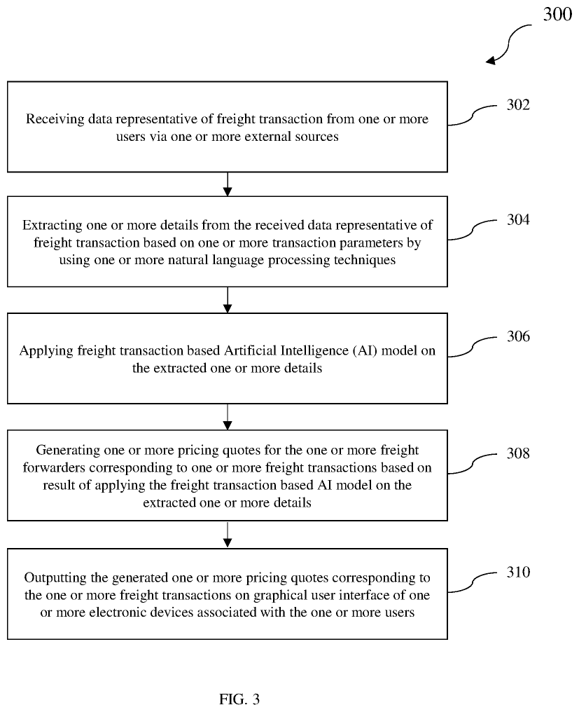

FIG. 3 is a process flow diagram illustrating an exemplary method 300 for facilitating one or more freight transactions, in accordance with an embodiment of the present disclosure. At step 302, data representative of freight transaction is received from one or more users 116 via one or more external sources. In an exemplary embodiment of the present disclosure, the data representative of freight transaction includes one or more queries of the one or more users 116, one or more instructions from the one or more users 116, labelled data and the like. In an exemplary embodiment of the present disclosure, the one or more users 116 include one or more freight forwarders 118, one or more shippers 120, one or more carriers 122 and the like. The one or more freight forwarders 118 are agents acting as consolidators of freight. In an embodiment of the present disclosure, the one or more external sources include virtual assistant, web browser, messaging platform and the like. In an alternative embodiment of the present disclosure, the data representative of freight transaction may be received from one or more external servers 110. In an exemplary embodiment of the present disclosure, the one or more external servers 110 include one or more Enterprise resource planning (ERP) servers and the like. In an embodiment of the present disclosure, the data representative of freight transaction may be received via one or more mediums. In an exemplary embodiment of the present disclosure, the one or more mediums include one or more voice-based messages from the one or more users 116, one or more text-based messages from the one or more users 116 and the like.

At step 304, one or more details are extracted from the received data representative of freight transaction based on one or more transaction parameters by using one or more natural language processing techniques. The one or more transaction parameters include freight order details, commodity, description, weight, source, destination, volume, consignee, shipper and the like. In an exemplary embodiment of the present disclosure, the one or more details include location of the one or more users 116, one or more instructions associated with the one or more users 116 and one or more price parameters associated with the one or more users 116. In an exemplary embodiment of the present disclosure, the one or more natural language processing techniques include a sentiment analysis technique, a text summarization technique and the like.

At step 306, freight transaction based Artificial Intelligence (AI) model is applied on the extracted one or more details.

At step 308, one or more pricing quotes is generated for the one or more freight forwarders 118 corresponding to one or more freight transactions based on result of applying the freight transaction based AI model on the extracted one or more details. In an alternate embodiment of the present disclosure, the one or more pricing quotes for the one or more freight forwarders 118 may be fetched from the one or more service providers via one or more communication networks. In an exemplary embodiment of the present disclosure, the one or more communication networks may include electronic mail, messaging platform and the like. In an alternative embodiment of the present disclosure, one or more unknown parameters are embedded by using one or more algorithms to generate data for the one or more unknown parameters to provide the one or more pricing quotes to the one or more users 116. In an exemplary embodiment of the present disclosure, the one or more algorithms include agglomerative clustering, K—nearest neighbour algorithms and the like.

At step 310, the generated one or more pricing quotes corresponding to the one or more freight transactions are outputted on graphical user interface of one or more electronic devices 102 associated with the one or more users 116. The one or more electronic devices 102 may be a laptop computer, desktop computer, tablet computer, smartphone, wearable device, smart watch, virtual assistant device and the like.

In an embodiment of the present disclosure, the method 300 includes analyzing the one or more pricing quotes provided by the one or more service providers to segregate at least one of the one or more pricing quotes based on the one or more transaction parameters provided by the one or more users 116. The method 300 includes determining one or more analysis parameters by analyzing the one or more pricing quotes. In an exemplary embodiment of the present disclosure, the one or more analysis parameters include one or more advantages associated with one or more service providers, one or more disadvantages associated with the one or more service providers and the like. Further, the determined one or more analysis parameters are outputted on graphical user interface of the one or more electronic devices 102.

Further, the method 300 includes receiving one or more updates from the one or more service provides about the one or more pricing quotes. In an embodiment of the present disclosure, the one or more service providers provides the one or more updates via the one or more service provider devices 108. The one or more service provider devices 108 may be a laptop computer, desktop computer, tablet computer, smartphone, wearable device, smart watch, virtual assistant device and the like. The one or more updates include an increase in the one or more pricing quotes, a decrease in the one or more pricing quotes and the like. Further, the method 300 includes customizing the one or more price quotes based on the received one or more updates. The customized one or more price quotes is outputted on graphical user interface of the one or more electronic devices 102. In an embodiment of the present disclosure, the customized one or more price quotes are outputted to the one or more freight forwarders 118 after a pre-defined interval of time. The method 300 includes receiving a final price quote associated with the one or more pricing quotes from the one or more freight forwarders 118. Furthermore, the method 300 includes generating a notification associated with the final price quote for executing a shipment process of one or more orders associated with the one or more users 116. In an embodiment of the present disclosure, the method 300 includes receiving one or more updates related to exception in the one or more orders during shipment process of one or more orders, such that each user may be notified about the received one or more updates.

Further, the method 300 includes tracking the one or more orders associated with the one or more users 116 upon execution of shipment process. Further, the method 300 includes receiving one or more order parameters associated with the one or more orders from the one or more users 116. In an exemplary embodiment of the present disclosure, the one or more order parameters include an order number, destination of the one or more orders, type of the one or more orders and the like. The method 300 includes fetching order information associated with the one or more orders based on the result of tracking the one or more orders and the received one or more order parameters. The order information includes one or more order status details, one or more driver details and one or more destination details associated with the one or more orders. In an exemplary embodiment of the present disclosure, the one or more order status details include an order number, estimated delivery date and time associated with the one or more orders, number of units of a product, a type of order, carrier name, shipper name and the like. In an exemplary embodiment of the present disclosure, the one or more driver details include name of a driver, contact number of the driver, vehicle number associated with the driver and the like. In an exemplary embodiment of the present disclosure, the one or more destination details include waiting time, number of parking slots, number of ramps and the like. Furthermore, the method 300 includes generating an order report corresponding to each order based on the fetched information. The generated report is transmitted on graphical user interface of the one or more electronic devices 102. In an embodiment of the present disclosure, the generated report may be transmitted via internet-based messaging platform, linked to natural language techniques and superimposition on required tracking milestones on maps for order lifecycle and the like.

Furthermore, the method 300 includes obtaining one or more responses associated with the shipment of the one or orders by prompting one or more questionnaires to the one or more users 116. In an embodiment of the present disclosure, the one or more responses may also be obtained in the form of feedback. Further, the method 300 includes determining a rating corresponding to each of one or more service providers based on the obtained one or more responses. The method 300 includes generating one or more recommendations to improve quality of service of the one or more service providers based on the generated rating and predefined information. The generated one or more recommendations are outputted on graphical user interface of the one or more service provider devices 108.

Further, the method 300 includes receiving one or more constraints from the one or more users 116. In an exemplary embodiment of the present disclosure, the one or more constrains include time, money, resources and the like. Further, the method 300 includes generating one or more optimize recommendations based on the received one or more constraints for decision and execution of the one or more orders. The generated one or more optimize recommendations are outputted on graphical user interface of the one or more electronic devices 102.

Furthermore, the method 300 includes translating one or more languages associated with the one or more pricing quotes, the one or more analysis parameter, the order report, the one or more recommendations, the one or more optimize recommendations and the like to another language as decided by the one or more users 116 by using the one or more natural language processing techniques.

In an embodiment of the present disclosure, the above-mentioned method steps may be performed by an interactive virtual assistant.

The method 300 may be implemented in any suitable hardware, software, firmware, or combination thereof.

Thus, various embodiments of the present computing system 104 provide a solution to facilitate the one or more freight transaction. The computing system 104 provides an efficient mechanism to facilitate one or more freight transaction by improving coordination and reducing manual coordination. Since, the computing system 104 generates the one or more pricing quotes based on result of applying the freight transaction based AI model on the extracted one or more details, likelihood of human errors may be reduced. Further, the computing system 104 may work as the interactive virtual assistant system to increases speed and accuracy of the one or more freight transactions. The computing system 104 reduces amount of hardware required for storing and bookkeeping as the data is stored on the cloud storage. Moreover, the computing system 104 may seamlessly integrate with the one or more external servers 110 through Application programming interface (API) and automate coordination across multiple communication networks resulting in reduction of human intervention by eliminating human coordination. Furthermore, the computing system 104 generates the order report having order information corresponding to each order. The computing system 104 also generates the one or more recommendations to improve quality of service of the one or more service providers.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating one or more freight transactions, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data receiver module configured to receive data representative of freight transaction from one or more users via one or more external sources, wherein the data representative of freight transaction comprises: one or more queries of the one or more users, one or more instructions from the one or more users and labelled data, wherein the one or more users comprise: one or more freight forwarders, one or more shippers and one or more carriers and wherein the one or more external sources comprise: virtual assistant, web browser and messaging platform;
a data extraction module configured to extract one or more details from the received data representative of freight transaction based on one or more transaction parameters by using one or more natural language processing techniques, wherein the one or more details comprise: location of the one or more users, one or more instructions associated with the one or more users and one or more price parameters associated with the one or more users;
a model application module configured to apply freight transaction based Artificial Intelligence (AI) model on the extracted one or more details;
a data generation module configured to generate one or more pricing quotes for the one or more freight forwarders corresponding to one or more freight transactions based on result of applying the freight transaction-based AI model on the extracted one or more details; and
a data output module configured to output the generated one or more pricing quotes corresponding to the one or more freight transactions on graphical user interface of one or more electronic devices associated with the one or more users.

2. The computing system of claim 1, wherein the one or more transaction parameters comprise: freight order details, commodity, description, weight, source, destination, volume, consignee and shipper.

3. The computing system of claim 1, further comprises data determination module configured to determine one or more analysis parameters by analyzing the one or more pricing quotes, wherein the one or more analysis parameters comprise: one or more advantages associated with one or more service providers and one or more disadvantages associated with the one or more service providers.

4. The computing system of claim 1, further comprises a data execution module configured to:
receive a final price quote associated with the one or more pricing quotes from the one or more freight forwarders; and
generate a notification associated with the final price quote for executing a shipment process of one or more orders associated with the one or more users.

5. The computing system of claim 4, further comprises a report generation module configured to:
track the one or more orders associated with the one or more users upon execution of shipment process;
receive one or more order parameters associated with the one or more orders from the one or more users, wherein the one or more order parameters comprise: an order number, destination of the one or more orders and type of the one or more orders;
fetch order information associated with the one or more orders based on the result of tracking the one or more orders and the received one or more order parameters, wherein the order information comprises: one or more order status details, one or more driver details and one or more destination details associated with the one or more orders, wherein the one or more order status details comprise: an order number, estimated delivery date and time associated with the one or more orders, number of units of a product, a type of order, carrier name and shipper name, wherein the one or more driver details comprise name of a driver, contact number of the driver and vehicle number associated with the driver and wherein the one or more destination details comprise: waiting time, number of parking slots and number of ramps; and
generate an order report corresponding to each order based on the fetched information, wherein the generated report is transmitted on graphical user interface of the one or more electronic devices.

6. The computing system of claim 1, further comprises a recommendation module configured to:
obtain one or more responses associated with the shipment of the one or orders by prompting one or more questionnaires to the one or more users;
determine a rating corresponding to each of one or more service providers based on the obtained one or more responses;
generate one or more recommendations to improve quality of service of the one or more service providers based on the generated rating and predefined information, wherein the generated one or more recommendations are outputted on graphical user interface of one or more service provider devices.

7. The computing system of claim 1, further comprises a data customization module configured to:
receive one or more updates from one or more service provides about the one or more pricing quotes, wherein the one or more updates comprise: an increase in the one or more pricing quotes and a decrease in the one or more pricing quotes; and
customize the one or more price quotes based on the received one or more updates, wherein the customized one or more price quotes is outputted on graphical user interface of the one or more electronic devices.

8. The computing system of claim 1, further comprises a data optimization module configured to:
receive one or more constraints from the one or more users, the one or more constrains comprise: time, money and resources; and
generate one or more optimize recommendations based on the received one or more constraints for decision and execution of the one or more orders, wherein the generated one or more optimize recommendations are outputted on graphical user interface of the one or more electronic devices.

9. A method for facilitating one or more freight transactions, the method comprising:
receiving, by one or more hardware processors, data representative of freight transaction from one or more users via one or more external sources, wherein the data representative of freight transaction comprises: one or more queries of the one or more users, one or more instructions from the one or more users and labelled data, wherein the one or more users comprise: one or more freight forwarders, one or more shippers and one or more carriers and wherein the one or more external sources comprise: virtual assistant, web browser and messaging platform;
extracting, by the one or more hardware processors, one or more details from the received data representative of freight transaction based on one or more transaction parameters by using one or more natural language processing techniques, wherein the one or more details comprise: location of the one or more users, one or more instructions associated with the one or more users and one or more price parameters associated with the one or more users;
applying, by the one or more hardware processors, freight transaction based Artificial Intelligence (AI) model on the extracted one or more details;
generating, by the one or more hardware processors, one or more pricing quotes for the one or more freight forwarders corresponding to one or more freight transactions based on result of applying the freight transaction-based AI model on the extracted one or more details; and
outputting, by the one or more hardware processors, the generated one or more pricing quotes corresponding to the one or more freight transactions on graphical user interface of one or more electronic devices associated with the one or more users.

10. The method of claim 9, wherein the one or more transaction parameters comprise: freight order details, commodity, description, weight, source, destination, volume, consignee and shipper.

11. The method of claim 9, further comprises determining one or more analysis parameters by analyzing the one or more pricing quotes, wherein the one or more analysis parameters comprise: one or more advantages associated with one or more service providers and one or more disadvantages associated with the one or more service providers.

12. The method of claim 9, further comprises:
receiving a final price quote associated with the one or more pricing quotes from the one or more freight forwarders; and
generating a notification associated with the final price quote for executing a shipment process of one or more orders associated with the one or more users.

13. The method of claim 12, further comprises:
tracking the one or more orders associated with the one or more users upon execution of shipment process;
receiving one or more order parameters associated with the one or more orders from the one or more users, wherein the one or more order parameters comprise: an order number, destination of the one or more orders and type of the one or more orders;
fetching order information associated with the one or more orders based on the result of tracking the one or more orders and the received one or more order parameters, wherein the order information comprises: one or more order status details, one or more driver details and one or more destination details associated with the one or more orders, wherein the one or more order status details comprise: an order number, estimated delivery date and time associated with the one or more orders, number of units of a product, a type of order, carrier name and shipper name, wherein the one or more driver details comprise name of a driver, contact number of the driver and vehicle number associated with the driver and wherein the one or more destination details comprise: waiting time, number of parking slots and number of ramps; and
generating an order report corresponding to each order based on the fetched information, wherein the generated report is transmitted on graphical user interface of the one or more electronic devices.

14. The method of claim 9, further comprises:
obtaining one or more responses associated with the shipment of the one or orders by prompting one or more questionnaires to the one or more users;
determining a rating corresponding to each of one or more service providers based on the obtained one or more responses;
generating one or more recommendations to improve quality of service of the one or more service providers based on the generated rating and predefined information, wherein the generated one or more recommendations are outputted on graphical user interface of one or more service provider devices.

15. The method of claim 9, further comprises:
receiving one or more updates from one or more service provides about the one or more pricing quotes, wherein the one or more updates comprise: an increase in the one or more pricing quotes and a decrease in the one or more pricing quotes; and
customizing the one or more price quotes based on the received one or more updates, wherein the customized one or more price quotes is outputted on graphical user interface of the one or more electronic devices.

16. The method of claim 1, further comprises:
receiving one or more constraints from the one or more users, the one or more constrains comprise: time, money and resources; and
generating one or more optimize recommendations based on the received one or more constraints for decision and execution of the one or more orders, wherein the generated one or more optimize recommendations are outputted on graphical user interface of the one or more electronic devices.

17. A non-transitory computer-readable storage medium having instructions stored therein that, when executed by a hardware processor, cause the processor to perform the method steps comprising:
receiving, by one or more hardware processors, data representative of freight transaction from one or more users via one or more external sources, wherein the data representative of freight transaction comprises: one or more queries of the one or more users, one or more instructions from the one or more users and labelled data, wherein the one or more users comprise: one or more freight forwarders, one or more shippers and one or more carriers and wherein the one or more external sources comprise: virtual assistant, web browser and messaging platform;
extracting, by the one or more hardware processors, one or more details from the received data representative of freight transaction based on one or more transaction parameters by using one or more natural language processing techniques, wherein the one or more details comprise: location of the one or more users, one or more instructions associated with the one or more users and one or more price parameters associated with the one or more users;
applying, by the one or more hardware processors, freight transaction based Artificial Intelligence (AI) model on the extracted one or more details;
generating, by the one or more hardware processors, one or more pricing quotes for the one or more freight forwarders corresponding to one or more freight transactions based on result of applying the freight transaction-based AI model on the extracted one or more details; and
outputting, by the one or more hardware processors, the generated one or more pricing quotes corresponding to the one or more freight transactions on graphical user interface of one or more electronic devices associated with the one or more users.

18. The non-transitory computer-readable storage medium of claim 17, further comprises determining one or more analysis parameters by analyzing the one or more pricing quotes, wherein the one or more analysis parameters comprise: one or more advantages associated with one or more service providers and one or more disadvantages associated with the one or more service providers.

19. The non-transitory computer-readable storage medium of claim 17, further comprises:
receiving a final price quote associated with the one or more pricing quotes from the one or more freight forwarders; and
generating a notification associated with the final price quote for executing a shipment process of one or more orders associated with the one or more users.

20. The non-transitory computer-readable storage medium of claim 17, wherein the one or more parameters comprise: freight order details, commodity, description, weight, source, destination, volume, consignee and shipper.
